(19) United States
(12) Patent Application Publication
(10) Pub. No.: US 2008/0113835 A1
(43) Pub. Date: May 15, 2008

(54) ECCENTRIC TENSIONING DEVICE

(75) Inventors: Rainer Baumuller, Herzogenaurach (DE); Niels Flamig, Leinefelde (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/774,028

(22) Filed: Jul. 6, 2007

(30) Foreign Application Priority Data
Nov. 9, 2006 (DE) 102006053207.4

(51) Int. Cl. F16H 7/08

(52) U.S. Cl. 474/112

(57) ABSTRACT

An eccentric tensioning device for tensioning a traction means constructed, for example, as a flat or toothed belt in a traction means drive, is provided. Advantages are provided for the installation of tensioning devices and in the integration of the traction means in the traction means drive under assembly-specific aspects. This is accomplished through the use of an eccentric tensioning device for a traction means, with a track roller device, which includes a running disk and a rolling bearing provided for supporting the disk. A work eccentric supports the track roller device such that it can be displaced in a radial direction relative to the rotating axis of the rolling bearing according to the magnitude of the pivoting of the work eccentric. A torsion spring pretensions the work eccentric, and a fixing device secures the work eccentric in a mounting position, in which the torsion spring is located in a pretensioned state. A base plate structure is non-rotatably anchored on a flange surface provided for attaching to the eccentric tensioning device, wherein the fixing device is constructed such that this device automatically detaches in the scope of tightening an attachment screw, through which the eccentric tensioning device is screwed onto the flange surface.

### BACKGROUND

The present invention relates to an eccentric tensioning device for tensioning a traction means constructed, for example, as a flat belt or toothed belt, in a traction means drive. In particular, the invention here relates to an eccentric tensioning device, which is provided for integration into a traction means drive of an internal combustion engine, which automatically guarantees a required pretensioning of the traction means through an adjustment moment generated on the side of a spring device.

A tensioning device of the type noted above is known, for example, from DE 40 33 777 A1. This conventional tensioning device, also designated as a double eccentric tensioning device, comprises an adjustment eccentric, which makes available a bore arranged eccentrically for receiving an attachment screw. By means of the attachment screw, the tensioning device is mounted on a housing, especially a housing of the internal combustion engine, wherein the adjustment eccentric is supported by means of a base plate on the housing. Placed on this adjustment eccentric is a working or operating eccentric, with there being a slide bearing in an annular gap between a casing surface of the adjustment eccentric and an inner wall of the operating eccentric. On the outside, a roller bearing surrounds the operating eccentric, whose outer ring functions directly as a running disk, which sits as such in the installed state, i.e., in the operating state, on the traction means of the traction means drive and applies a force to this with a transverse force directed perpendicular to the running direction. For achieving a firm contact of the running disk on the traction means, between the base plate and the operating eccentric there is a torsion spring, which forces the operating eccentric and the running disk connected to this operating eccentric continuously into a position tensioning the traction means.

### SUMMARY

The invention is based on the objective of creating solutions, through which advantages are produced under assembly-specific aspects in the installation of tensioning devices and the integration of the traction means into the traction means drive.

This objective is achieved according to the invention by an eccentric tensioning device for a traction means drive, with:

a track roller device, which as such comprises a running disk and a rolling bearing provided for supporting this running disk,

a work eccentric for supporting the track roller device such that this can be displaced in a radial direction relative to the rotating axis of the rolling bearing according to the magnitude of the pivoting of the work eccentric,

a torsion spring for pretensioning the work eccentric,

a fixing device for securing the work eccentric in a mounting position, in which the torsion spring is located in a pretensioned state, and

a base plate structure that can be anchored locked in rotation on a flange surface provided for attaching to the eccentric tensioning device,

wherein the fixing device is constructed such that this automatically detaches within the scope of tightening an attachment screw, through which the eccentric tensioning device is attached to the flange surface.

Therefore, in an advantageous way it becomes possible to create a tensioning device, in which during the mounting of the traction means the work or operating eccentric is fixed in an end position pivoted away from the traction means running path under pretensioning of the torsion spring, wherein this secured state can be canceled within the scope of installing the tensioning device. The work eccentric is preferably fixed in each locking or mounting position so that relative movements between the work eccentric and the base plate are prevented.

According to an especially preferred embodiment of the invention, the fixing device is constructed such that this automatically detaches in the course of tightening the attachment screw, through which the eccentric tensioning device, in particular the adjustment eccentric of this device, is screwed onto the flange surface carrying the tensioning device. This automatic detachment or release process of the fixing device can be initiated, in particular, in that a free switching path is traversed or an axial play initially provided in the tensioning device is overcome within the scope of attaching the eccentric tensioning device to the flange surface of components of the tensioning device under the effect of the axial force applied by the attachment screw. In the course of overcoming this axial play, especially against an axial force applied by the torsion spring or by secondary support structures, an engagement structure of the fixing device can be brought into a released state.

The engagement structure is preferably coupled rigidly with the work eccentric. In particular, it is possible to shape the engagement structure so that this is connected to the work eccentric via a pointing arm or is constructed especially directly as an indexer produced as one piece with the work eccentric.

The fixing device according to the invention is preferably shaped so that in the mounting position the engagement structure is engaged with a holding element, which is provided by the base plate. The engagement structure is brought into the released state preferably through axial displacement of the engagement structure relative to the holding element.

The spring device provided for generating the torsion moment pivoting the work eccentric is preferably constructed as a helical spring. This helical spring can be embodied so that it has several spring windings. The helical spring can be constructed as a leg-less helical spring, so that the forces generated by this helical spring are introduced via the ends of the spring ends and optionally via a peripheral section offset from these ends by an angle of typically 90° into the appropriate components loaded by the spring. The spring can also be provided in the area of the spring ends with anchoring structures, especially in the form of hook sections. These hook sections can be produced especially by the wire ends of the spring structure bent radially inwards or outwards. The spring device can be shaped in terms of the cross section of the spring wire so that this has a polygonal, in particular a square or flat cross section. Furthermore, the spring device is preferably shaped so that in the installed state, this is also at least slightly flattened, e.g., to 30% of its length in the axially unloaded state.

The tensioning device according to the invention preferably comprises a damping or braking device, which as such is used for generating an eccentric braking moment, through which the pivoting of the work eccentric is braked. This damping or braking device can be formed by an axially loaded disk structure, by a radially loaded bushing structure, or also by an axially loaded cone structure. Preferably, at least one part of the loading force acting on this damping or braking device is generated or transmitted by the torsion spring. At least one of the friction partners used for generating the friction force is preferably made from a plastic material optionally loaded with filler.

The work eccentric can be made from a plastic material. Furthermore, it is also possible to construct the work eccentric in one piece with the inner ring of the rolling bearing. Furthermore, it is also possible to construct the running disk in one piece with the outer ring of the rolling bearing.

According to an especially preferred embodiment of the invention, the work eccentric is supported on an adjustment eccentric. Through the fixing device according to the invention or especially through an additional fixing device constructed, for example, as a shearing structure, preferably the position of the work eccentric is also fixed relative to the adjustment eccentric. It is possible to shape the tensioning device structurally so that the adjustment eccentric can be displaced by a small distance axially relative to the work eccentric or a base plate, wherein the released state of the fixing device can be generated in the course of the axial displacement of the adjustment eccentric, especially under the action of the attachment screw.

The base plate is preferably shaped such that it comprises an annular disk section provided for mounting on the flange surface. This annular disk section can be shaped so that this is coupled locked in rotation with a bearing bushing in the area of an inner peripheral edge.

On the base plate, a projection or some other engagement structure can be formed, which as such is used for rotationally locked anchoring of the base plate on the flange surface. Preferably, the projection is shaped so that the rotationally locked anchoring of the base plate on the flange surface is reached before the fixing device is led into a released state or before the axial release path has been overcome.

As an alternative to the previously described measures, it is also possible to shape the tensioning device according to the invention so that the creation of the released state is not realized through axial loading of the tension roller device, but instead, for example, by pivoting the work eccentric back against the pivoting direction caused by the torsion spring. In this state pivoted back even farther, a spring elastic locking element preloaded, for example, in a released position, can be unlocked and here can release the work eccentric, so that this is pivoted towards the traction means running path under the effect of the torsion spring and thus the running disk is lowered onto the traction means.

It is also possible to shape the tensioning device so that the generation of the released state is realized by an overload moment also introduced into the work eccentric and acting in the direction of the tensioning moment generated by the torsion spring.

Preferably securing means are provided, through which re-engagement of the fixing device is prevented. In this way it becomes possible to guarantee that no unintentional relocking of the fixing device is performed during the operation of the tensioning device.

The invention includes, in particular, the following variants:

Variant 1

Before the mounting of the tensioning device, this is pretensioned into the delivery state. A radially directed indexer connected to the operating eccentric is supported with a force-generated fit and/or a positive fit on a holding element of the base plate or the adjustment eccentric. Here, the work eccentric and thus the indexer connected to it are pressed and thus fixed in position against the holding element of the base plate due to the force of the torsion spring with a rotationally non-positive fit. The indexer assumes this position through a limited axial displacement of the work eccentric relative to the adjustment eccentric or the base plate, wherein this displacement is realized in the direction of an axial force component of the torsion spring.

From this starting position, the tensioning device is positioned loosely, i.e., without rigid attachment, to the internal combustion engine, with the help of the attachment screw. By means of the base plate in connection with an axially extending projection, which engages in a corresponding bore or receptacle of the internal combustion engine in the area of the flange surface, an aligned installation position of the tensioning device is set. In the mounting position, the operating eccentric is fixed at an end stop, which is also designated as a hot stop, whereby the traction means, in particular a belt, can be mounted easily, i.e., can be placed on all of the running disks of the traction means drive.

After mounting the traction means successfully, with the help of the attachment screw the tensioning device is fixed rigidly to the housing of the internal combustion engine. In sync with the tightening of the attachment screw, the adjustment eccentric and the base plate connected to this eccentric are displaced axially in the direction of the internal combustion engine, whereby the indexer connected in one piece with the base plate detaches from the holding element and the torsion spring turns the operating eccentric into a position pretensioning the traction means. The release of the indexer and thus the work eccentric from the locking during the mounting position is then reached as soon as an axial play “S” between the work eccentric and the base plate or the adjustment eccentric is equalized or reduced by tightening the tensioning device.

Variant 2

For achieving effective transport locking, which prevents relative movement between the work eccentric and the base plate in the mounting position, an indexer connected to the work eccentric or a similarly formed object is actively connected to a stop of the base plate. The locking can be realized through suitable shaping of the base plate alone or with the help of additional elements, e.g., splints or a plate, which are removed after the traction means are placed, in order to tension the traction means.

Variant 3

Another variant for positioning the operating or work eccentric in a mounting position provides for the shaping of the locking device for maintaining the pretensioned torsion spring, so that it does not exceed the radial outer contours of the tensioning unit. Suitable for this purpose is, for example, a groove or recess formed on the end on the side of the work eccentric adjacent to the flange surface of the internal combustion engine in the work eccentric or in the base plate, in which engages a locking device engaging through a positive fit, force-generated fit, or through a combination of these two fits, in order to prevent rotational movement of the work eccentric relative to the base plate or the adjustment eccentric in the mounting position.

The object interacting with the groove or the recess, which is located according to the arrangement of the connecting rod either on the base plate or the work eccentric, can be constructed as a bent part, cast part, or as an add-on part (e.g., as a dowel pin). The projection of the object out of the groove or the recess in the direction of the beginning of the groove is prevented by the clamping of the work eccentric and the associated limiting of the axial play of the tensioning unit. According to another embodiment, the object encompasses the work eccentric. In the mounting position, in particular a molded part connected to the base plate engages in a groove or recess of the work eccentric. Due to the axial force of the torsion spring, there is effective locking between the base plate and the work eccentric in the mounting position.

The invention is directed, in particular, to tensioning devices, which guarantee a nearly constant pretensioning force of the traction means under all operating conditions and with which a long service life can be achieved. The measures according to the invention allow a semi-automated setting of the desired traction means force for the first assembly and for service work for equalizing:
diameter and positional tolerances of the individual disks of the traction means drive;
length tolerances of the traction means, especially toothed belts;
belt wear;
temperature differences;
and effects due to the dynamic behavior of the internal combustion engine.

### BRIEF DESCRIPTION OF THE DRAWINGS

Additional details and features of the invention emerge from the following description in connection with the drawing. Shown are:

FIG. 1 an axial section view illustrating the construction of a tensioning device according to the invention with an operating eccentric and an adjustment eccentric and also a fixing device according to the invention;

FIG. 2 a detail view for illustrating the construction of a shearing structure of the tensioning device according to FIG. 1;

FIG. 3 a perspective view of a tensioning device in a pretensioned, locked state;

FIG. 4 a side view of the tensioning device according to FIG. 3 in a state, in which the fixing device has just been led into a released position;

FIG. 5 a view of the tensioning device in a state, in which the unlocked indexer has just been pushed through under the holding device;

FIG. 6 a perspective view of another tensioning device in pretensioned or locked state with a slightly modified shape of the holding device and the indexer interacting with this device;

FIG. 7 another perspective view of a third variant of a tensioning device, likewise in a pretensioned or locked state;

FIG. 8 a perspective view of a base plate of a tensioning device with another fixing device or locking structure for fixing the work eccentric in a mounting position.

### DETAILED DESCRIPTION OF THE PREFERRED EMBODIMENTS

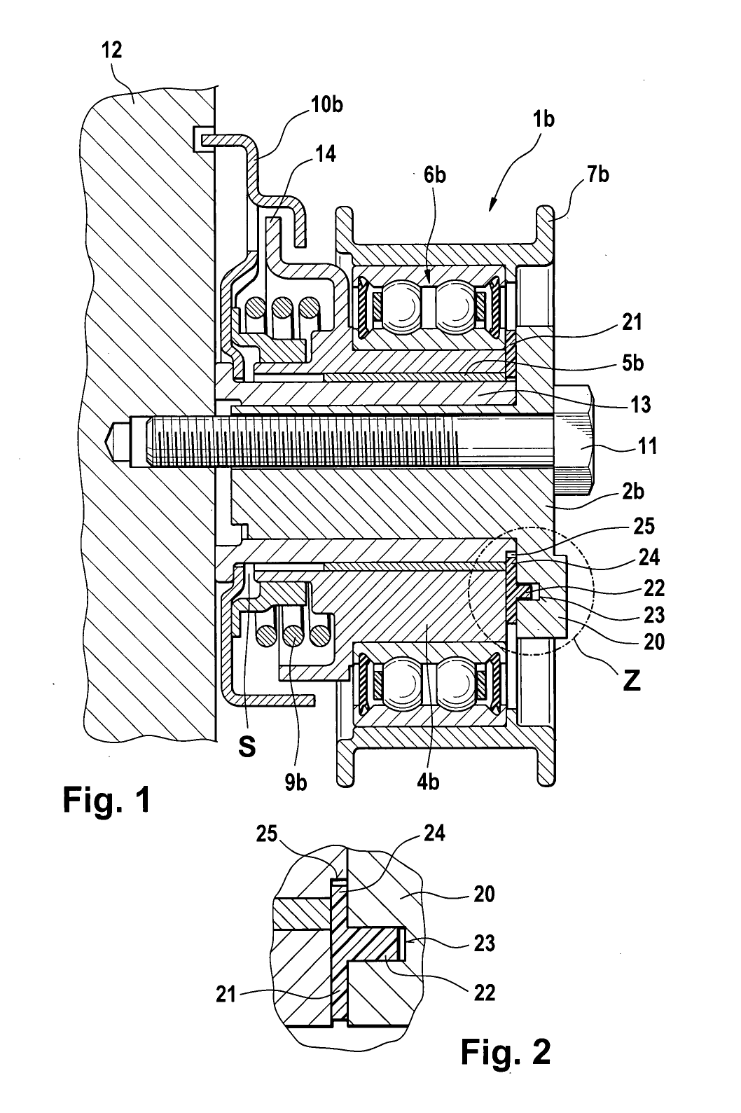

In FIG. 1, a first variant of a tensioning device 1b according to the invention is shown in which an adjustment eccentric 2b is fixed to a housing 12 via an attachment screw 11. The adjustment eccentric 2b is inserted into a hollow cylindrical carrier body 13, by means of which the tensioning device 1b is supported on the housing 12. The tensioning device comprises an operating eccentric 4b, which is supported on the carrier body 13 so that it can rotate about a plain or slide bearing 5b.

On the outside, the operating eccentric 4b is enclosed by a rolling bearing 6b, which carries a running disk 7b. A torsion spring 9b is arranged between a base plate 10b and the operating eccentric 4b. An indexer 14 arranged locally on the operating eccentric 4b has, in particular, the task of visually indicating the position of the operating eccentric 4b relative to the base plate 10b. The construction of the tensioning device 1b encloses an axial play “s” between an end face of the operating eccentric 4b and the base plate 10b. In terms of the other reference numbers 20 to 25 in this view, refer to the following statements on FIG. 2.

FIG. 2 shows the detail “Z” according to FIG. 1 at an enlarged scale. For the initial fixing of the adjustment eccentric 2b, a friction disk 21, which has an axially projecting pin 22 that engages with a positive fit in a receptacle 23 shaped as a pocket bore, is inserted between an end of the operating eccentric 4b and a rim 20 of the adjustment eccentric 2b. Furthermore, the friction disk 21 encloses on the inner periphery a radially inwardly directed shear pin 24, which engages in an end groove 25 of the carrier body 13.

In this way it becomes possible to couple the operating eccentric 4b and the adjustment eccentric 2b first rigidly with each other in a position that creates a maximum distance of the running disk 7b (FIG. 1) from a traction means path. In a first partially mounted state, the base plate 10b is already locked in rotation on the housing 12 by means of its projection 10b, but the pretensioned, secured tensioning device according to the invention has not yet been unlocked.

The operating eccentric 4b and the adjustment eccentric 2b are aligned relative to each other so that the peripheral wall of the running disk 7b assumes its greatest possible distance from the running path of the traction means to be tensioned in the traction means drive. In this state, the traction means can be placed in a simple way onto the associated running disks of the belt drive.

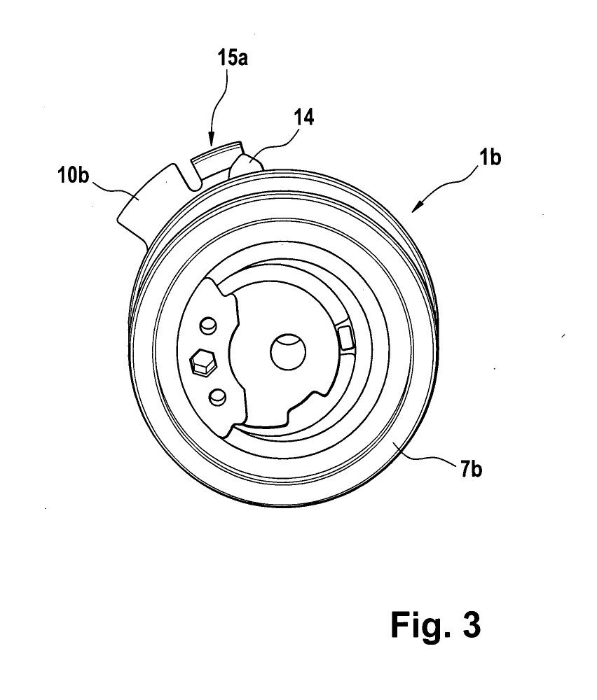

As can be seen from FIG. 3, the indexer 14 of the operating eccentric 4b is in active connection with a holding element 15a allocated to the base plate 10b. By locking the indexer 14 on the holding element 15a, it becomes possible to secure the operating eccentric 4b coupled rigidly with the indexer 14 and constructed in particular in one piece in the pretensioned position shown here.

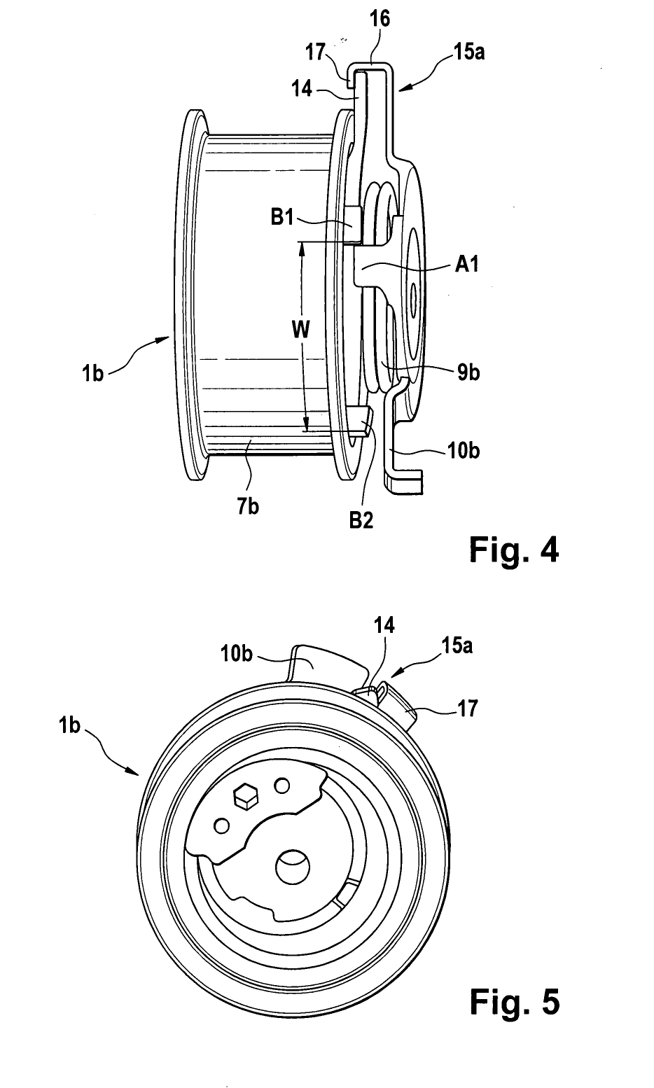

As shown in FIG. 4, the holding element 15a comprises, for example, a U-shaped bend 16 formed on the end, which forms a free radially inwardly directed rim 17. For achieving the just reached unlocking position that can be seen here, initially the running disk 7b is shifted in connection with the operating eccentric 4b against an axial force exerted by the torsion spring 9b in the direction of the base plate 10b. The shifting is enabled by a permissible axial free switching path S between the operating eccentric 4b and the base plate 10b.

Then, under the effect of the torsion spring 9b, there is a limited relative rotation between the indexer 14 and the holding element 16a. The permissible maximum pivoting angle W is fixed by pivoting stop structures B1, B2. These pivoting stop structures form components of the operating eccentric 4b. An inner stop A1 constructed in one piece with the base plate 10b can be displaced between these two pivoting stop structures B1, B2.

The securing device realized between the indexer and the holding element 16a can also be realized structurally in some other way, especially as discussed in more detail below. In particular, it is possible to shape this securing device so that, for example, a local overlap between the indexer 14 and the rim 17 of the holding element 16a is achieved, and the indexer is secured through corresponding stops supporting the indexer in the pivoting direction, wherein, under the effect of the axial force of the torsion spring 9b the indexer 14 is forced into the catch structure formed on the holding element 16a.

FIG. 5 shows the tensioning device in a state, in which the indexer 14 is already located outside the holding element 16a. The operating eccentric 4b can pivot in its operating position, spring loaded in this system state, until there is force balance between the radial force generated on the side of the operating eccentric under the effect of the torsion spring and the traction means reaction forces contacting the running disk.

For securing the mounting position and creating effective transport locking, a positive-fit connection is provided in addition to the non-positive support of the indexer 14. For this purpose, for example, a local recess, in which the indexer 14 engages with a positive fit, in the rim 17 of the holding element 16a is suitable.

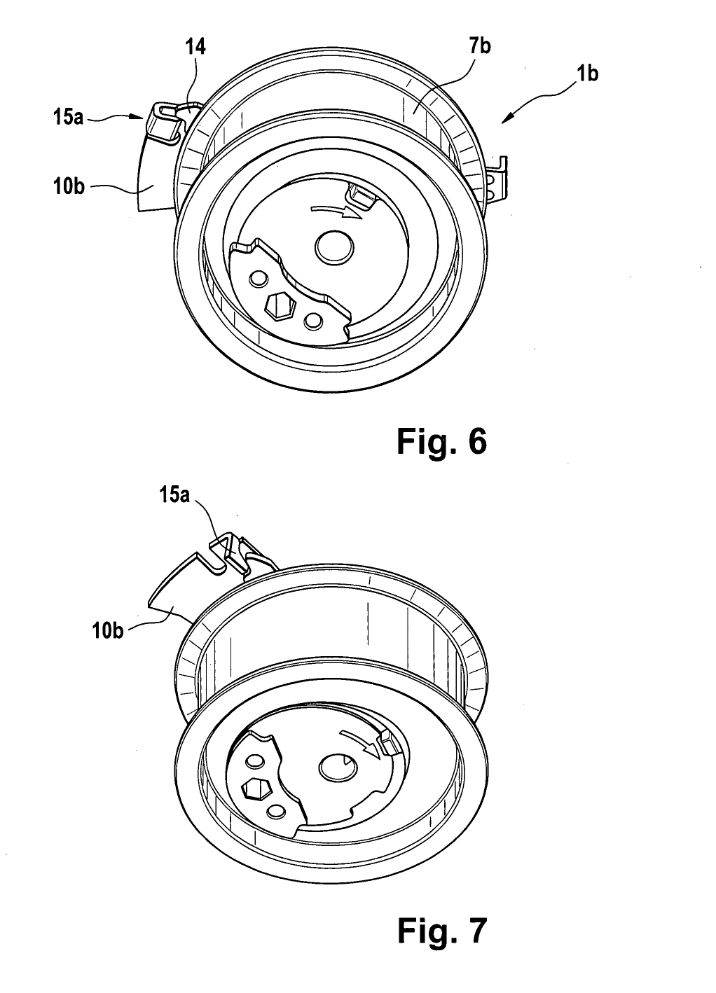

In FIG. 6, another variant of a tensioning device according to the invention is shown. In this variant, the holding device 16a supporting the indexer 14 is shaped so that under the effect of the force acting on the holding device 15 by the indexer 14, a certain axial locking of the indexer 14 is achieved. In the region of the contact surfaces of the indexer 14 and the holding device 15 coming in contact with each other, for this purpose, for example, concave/convex mating geometries can be constructed.

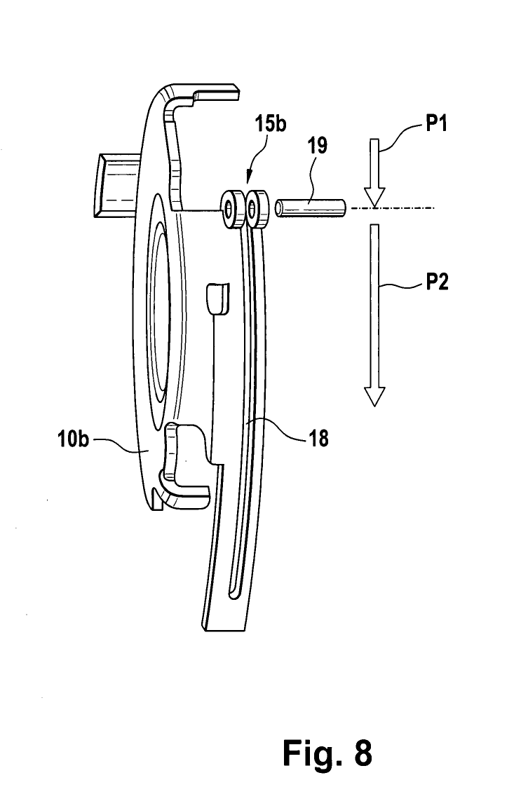

In the variant according to FIG. 7, the holding device 16a is produced by a stop bracket section constructed in one piece with the base plate 10b.

In the area of the contact surface of the contact bracket section supporting the indexer 14, a slight recess can be formed, in which the indexer 14 sits secured sufficiently under the effect of the pretensioning force generated by the torsion spring.

FIG. 8 shows in one perspective the base plate 10 for another variant of a fixing device. A holding element 15b constructed here in one piece with the base plate 10b encloses the plate following the radius of curvature of the running disk 7b. A slit 18 formed in the plate is defined for guiding the indexer 14. In the pretensioned position corresponding to the mounting position of the operating eccentric 4b relative to the base plate 10b or the adjustment eccentric 2b, the indexer 14 is fixed in the end position by a separate pin 19.

The rolling bearing 6 of the tensioning device is preferably constructed as a radial rolling bearing 6, which is comprised of an inner bearing ring and an outer bearing ring as well as from a plurality of cylinder bodies rolling between the bearing rings in groove-shaped raceways and held by a bearing cage at a constant distance relative to each other. Axially on both sides of its rolling bearing there is a seal, with which the intermediate space formed as a grease storage area is sealed between the bearing rings, wherein this rolling bearing is distinguished in that it is constructed as a ball rolling bearing, whose rolling bearings are constructed as ball rollers each with two parallel side surfaces flattened symmetrically from a basic ball shape. Relative to a comparable ball bearing, this ball roller bearing offers increased bearing capacity due to the higher number of cylinder bodies that can be mounted and also due to the reduced installation space of the cylinder bodies together with an enlarged grease storage area. The cylinder bodies constructed as ball rollers are preferably shaped so that these preferably have a width between their side surfaces of approximately 70% of the diameter of their basic ball shape and can be inserted at first axially “flat” into the radial rolling bearing through a distance between the concentric bearing rings having a height of approximately 80% of the diameter of the basic ball shape of the cylinder body and can each be pivoted through a corresponding rotation by about 90° in the raceways of the bearing rings. The outer bearing ring here can form the running disk directly. The inner bearing ring can be formed directly by the work eccentric.

### LIST OF REFERENCE NUMBERS

1a Tensioning device
1b Tensioning device
2a Adjustment eccentric
2b Adjustment eccentric
3 Receptacle bore
4a Operating eccentric
4b Operating eccentric
5a Slide bearing
5b Slide bearing
6a Rolling bearing
6b Rolling bearing
7a Running disk
7b Running disk
8 Traction means
9a Torsion spring
9b Torsion spring
10a Base plate
10b Base plate
11 Attachment screw
12 Housing
13 Carrier body
14 Indexer
15a Holding element
15b Holding element
16 Bend
17 Rim
18 Slit
19 Pin

1. Eccentric tensioning device for a traction means drive, comprising:
a track roller device, which comprises a running disk and a rolling bearing provided for supporting the running disk,
a work eccentric for supporting the track roller device for displacement in a radial direction relative to a rotating axis of the rolling bearing according to a magnitude of pivoting of the work eccentric,
a torsion spring for pretensioning the work eccentric,
a fixing device for securing the work eccentric in a mounting position, in which the torsion spring is located in a pretensioned state,
a base plate structure, which can be non-rotatably anchored to a flange surface provided for attaching to the eccentric tensioning device,
wherein the fixing device is automatically movable from a first fixed state to a second detached during tightening of an attachment screw which fixes the eccentric tensioning device onto the flange surface.

2. Eccentric tensioning device according to claim 1, wherein an axial play is provided that is overcome via attachment of the eccentric tensioning device to the flange surface with the attachment screw.

3. Eccentric tensioning device according to claim 2, wherein the axial play is overcome against an axial force applied via the torsion spring.

4. Eccentric tensioning device according to claim 3, wherein an engagement structure connected to the work eccentric is led into a released state as the axial play is overcome.

5. Eccentric tensioning device according to claim 4, wherein the engagement structure is attached to the work eccentric via an indexer arm.

6. Eccentric tensioning device according to claim 5, wherein in an assembled state, the engagement structure engages with a holding element that is provided by the base plate.

7. Eccentric tensioning device according to claim 6, wherein the engagement structure is brought into the released state through axial displacement of the engagement structure relative to the holding element.

8. Eccentric tensioning device according to claim 1, wherein the spring device comprises a helical spring.

9. Eccentric tensioning device according to claim 1, further comprising a damping device that generates an eccentric braking moment counteracting a radial displacement of the track roller device.

10. Eccentric tensioning device according to claim 1, wherein the work eccentric is supported on an adjustment eccentric.

11. Eccentric tensioning device according to claim 1, wherein the work eccentric is displaceable axially and a released state can be provided through axial displacement of the adjustment eccentric under the effect of the attachment screw.

12. Eccentric tensioning device according to claim 11, wherein the base plate comprises an annular disk section provided for clamping onto the flange surface and the annular disk section is coupled locked in rotation with a carrier body in an area of an inner peripheral edge, and a holding element is formed on the base plate in an outer edge region of the base plate.

13. Eccentric tensioning device according to claim 12, wherein a projection is formed on the base plate for rotationally locked anchoring of the base plate on the flange surface.

14. Eccentric tensioning device according to claim 13, wherein the projection is constructed so that the rotationally locked anchoring of the base plate on the flange surface is achieved before the axial displacement is overcome.
